(19) United States
(12) Patent Application Publication
(10) Pub. No.: US 2025/0196770 A1
(43) Pub. Date: Jun. 19, 2025

(54) VEHICULAR INTERIOR MIRROR ASSEMBLY WITH VIBRATION DAMPENING ELEMENT

(71) Applicant: Magna Mirrors of America, Inc., Holland, MI (US)

(72) Inventor: Marshall A. Zerbe, Decatur, MI (US)

(21) Appl. No.: 18/983,532

(22) Filed: Dec. 17, 2024

Related U.S. Application Data
(60) Provisional application No. 63/611,220, filed on Dec. 18, 2023.

(51) Int. Cl. B60R 1/02; B60R 1/04

(52) U.S. Cl. CPC B60R 1/025; B60R 1/04

(57) ABSTRACT

A vehicular interior rearview mirror assembly includes a mirror head adjustable about a mounting structure including a mounting arm having a ball member received by a socket attached at structure of the mirror head and that is configured to mount the interior rearview mirror assembly at an interior portion of an interior cabin of a vehicle. The mirror head includes a mirror reflective element. With the vehicular interior rearview mirror assembly mounted at the interior portion of the interior cabin, the mirror head is adjustable by a driver of the vehicle to set a rearward view for the driver. A dampening element is disposed between the socket and structure of the mirror head. With the vehicular interior rearview mirror assembly mounted at the interior portion of the interior cabin, the dampening element at least partially attenuates vibrations from transferring from the mounting structure to the mirror head.

### CROSS REFERENCE TO RELATED APPLICATION

The present application claims the filing benefits of U.S. provisional application Ser. No. 63/611,220, filed Dec. 18, 2023, which is hereby incorporated herein by reference in its entirety.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a double ball pivot or joint mounting configuration where the mirror casing and reflective element are adjusted relative to the interior portion of a vehicle by pivotal movement about the double ball pivot configuration. The mirror casing and reflective element are pivotable about either or both of the ball pivot joints by a user that is adjusting a rearward field of view of the reflective element.

### SUMMARY OF THE INVENTION

A vehicular interior rearview mirror assembly includes a mounting structure configured to attach at an interior portion of a cabin of a vehicle equipped with the vehicular interior rearview mirror assembly. A mirror head is adjustable relative to the mounting structure. The mirror head accommodates a mirror reflective element. With the mounting structure attached at the interior portion of the cabin of the vehicle, the mirror head is adjustable by a driver of the vehicle to set a rearward view for the driver. A dampening element is disposed at the mirror head. With the mounting structure attached at the interior portion of the cabin of the vehicle, the dampening element at least partially attenuates vibrations from transferring from the mounting structure to the mirror head.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly; and

FIG. 2 is a sectional view of the interior rearview mirror assembly.

### DESCRIPTION OF THE PREFERRED EMBODIMENTS

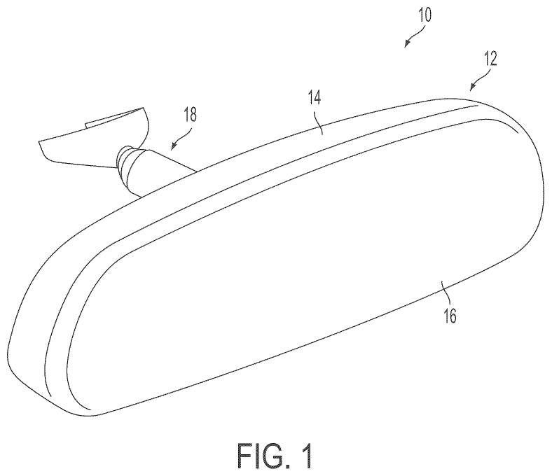

Referring now to the drawings and the illustrative embodiments depicted therein, an interior rearview mirror assembly 10 for a vehicle includes a mirror head 12 that includes a mirror casing 14 and a mirror reflective element 16 positioned at a front portion of the mirror casing 14 (FIG. 1). In the illustrated embodiment, the mirror head 12 of the mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 18 of the mirror assembly. The mirror reflective element 16 may comprise a variable reflectance mirror reflective element that varies its reflectance responsive to electrical current applied to conductive coatings or layers of the reflective element.

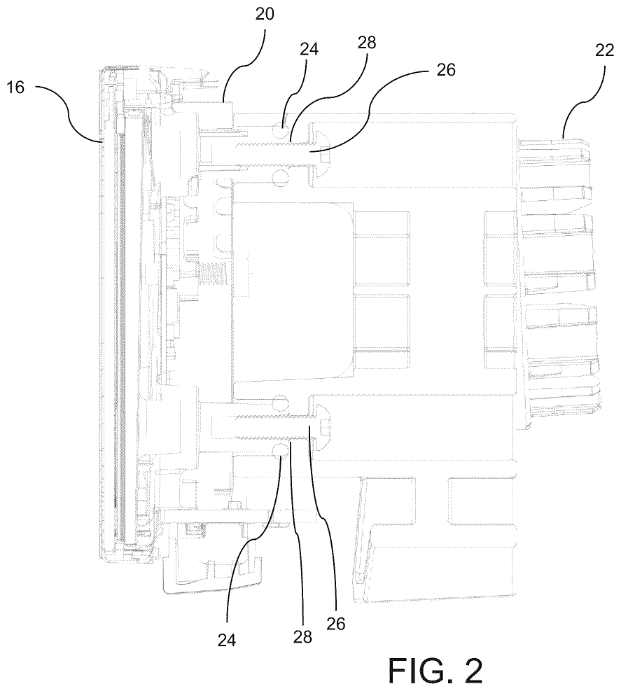

As shown in FIG. 2, the mirror reflective element 16 is attached to, such as adhesively attached to, a mirror back plate 20, which in turn may be attached to the mirror casing 14. Optionally, the mirror back plate 20 may be integrally formed with the mirror casing 14. In some examples, and as described further below, a video display screen may be disposed behind the mirror reflective element, such as at or adjacent to the rear surface of the mirror reflective element 16, and electrically operable to display images that are viewable to the driver of the vehicle through the mirror reflective element 16. The mirror back plate 20 and/or the mirror casing 14 are attached to or integrally formed with a socket element 22 of the mounting structure 18. The socket element 22 includes a receptacle or receiving portion that pivotally receives a ball member at an end of a mounting arm or stay of the mounting structure 18. The end of the mounting stay opposite the ball member is configured to attach at the interior portion of the vehicle (e.g., the in-cabin surface of the vehicle windshield, the headliner of the vehicle, and the like). Accordingly, during operation of the vehicle, vibrations may be transferred from the body and/or windshield of the vehicle through the mounting stay and socket element 22 to the mirror casing 14 and mirror reflective element 16. That is, as the vehicle travels along a road, vibrations caused by the vehicle's travel may be transferred through the mounting structure 18 to the mirror head 12. Vibrations of certain frequencies and amplitudes can cause decreases in optical clarity of reflections at the mirror reflective element 16 and/or video images displayed at the video display screen.

To reduce and/or eliminate the effect of vibrations on the mirror head 12, a dampening or dampener element 24 is disposed between the mounting structure 18 and the mirror head 12. The dampener element 24 at least partially absorbs or attenuates vibrations between the mirror head 12 and the mounting structure 18. In the illustrated example of FIG. 2, the dampener element 24 includes one or more O-rings that are formed of a rubber or rubber-like or elastomeric material and that are disposed at attachment locations of the socket element 22 to the back plate 20 (e.g., at an interface where the fasteners 26 attach the socket element 22 to the back plate 20).

It can be appreciated that the dampener element 24 may include one or more flexible gaskets, rubber stoppers, or any element made of a material that absorbs vibrations. Furthermore, the dampener element 24 may be disposed at any suitable position within the mirror assembly 10 so that the dampener element 24 absorbs and/or at least partially attenuates vibrations from transferring from the mounting structure 18 to the mirror head 12 and mirror reflective element 16. For example, the dampener element may be disposed between the mounting structure 18 and the mirror back plate 20 or between the mirror back plate 20 and the mirror reflective element 16. Optionally, the dampener element 24 may be disposed between the mounting structure 18 and the mirror casing 14, or between the mirror back plate 20 and the mirror casing 14, or at a different location that facilitates the absorption and attenuation of vibration between the mirror head 12 and the mounting structure 18, thus precluding vibration from travelling to the mirror reflective element 16 during vehicle operation.

As a result of the dampener element 24 incorporated into the mirror assembly 10, the mirror head 12 may experience a greater level of stability relative to the mounting structure 18. The optical clarity of the mirror reflective element 16 or displayed images may be enhanced due to the reduced vibration. The reduced vibration may also reduce the amount of effort and strain required for the driver to view the mirror reflective element 16. That is, improved stability of the mirror head 12 may provide more clear reflections for the driver and reduce distractions caused by a vibrating or moving mirror head.

Furthermore, in some examples, the mirror head 12 accommodates a driver monitoring camera or occupant monitoring camera for a driver monitoring system or occupant monitoring system of the vehicle. Due to the added stability provided by the dampener element 24 during vehicle operation, the quality of image data captured by the camera at the mirror head 12 may be improved. For example, motion blur may be reduced or eliminated from the video images captured by the camera. Moreover, a processing load of the driver monitoring system may be reduced as the system may receive more stable image data and thus more easily track the driver (e.g., eye position and gaze direction of the driver) and objects within the cabin of the vehicle between frames of captured image data.

With continued reference to FIG. 2, a plurality of fasteners 26 attach the socket element 22 to the mirror back plate 20 at fastener mounting locations or bosses or points or stanchions 28. The fastener 26 may be a threaded bolt or a similar type of fastening mechanism. The dampener elements 24 are disposed at the mounting locations 28 between the socket element 22 and the mirror back plate 20 (such as at threaded bosses or mounting stanchions at the back plate). The dampener element 24 may be adjacent to the fastener 26 or incorporated into the design of the fastener 26, thus having the dampener element 24 circumscribing the fastener 26 at the mounting location 28.

In other words, the one or more dampener elements 24 are disposed between the attachment interface of the socket 22 and the back plate 20. As shown in FIG. 2, the socket 22 includes recesses or receiving portions that respectively receive corresponding stanchions 28 of the back plate 20, such as to locate the socket 22 at the back plate 20 and preclude lateral movement of the socket 22 and back plate 20 relative to one another. Threaded fasteners 26 extend through the socket 22 and are received at threaded receivers of the stanchions 28 to secure the socket 22 relative to the back plate 20. The respective dampener elements 24 are disposed between the socket 22 and the back plate 20 at this attachment interface to attenuate vibrations travelling from the vehicle and mounting structure 18 toward the mirror head 12 and mirror reflective element 16. For example, the O-rings 24 may be disposed about an outer circumferential surface of the stanchions 28 to be disposed radially between the stanchions 28 of the back plate 20 and the receiving portions of the socket 22. Optionally, the O-rings 24 may be disposed at an end surface of the stanchions 28 to be disposed axially between the stanchions 28 of the back plate 20 and the receiving portions of the socket 22. Further, the O-rings 24 may be disposed along and circumscribe the threaded fasteners 26 to be disposed radially between the threaded fasteners 26 and/or stanchions 28 of the back plate 20 and the receiving portions of the socket 22 and/or to be disposed axially between the stanchions 28 of the back plate 20 and the receiving portions of the socket 22.

Optionally, the dampener element may be disposed between the mounting structure and the mirror casing or socket element, whereby the fastener may be in the form of a snap or similar style of attachment mechanism at an aperture or recess in the mirror casing. This configuration may have the aperture or recess circumscribed by a dampener element or vibration-absorbing gasket at the mirror casing. That is, in some examples the dampening element is disposed between the mounting structure and the mirror casing, where the socket element may attach at the mirror casing, such as snap attach at an aperture or recess in the mirror casing, and the dampening element may be between the socket element and the mirror casing, such as circumscribing the aperture or opening of the recess at the mirror casing.

Vibrational force inherent in vehicular operation may travel through the mounting structure of the interior mirror assembly and affect the optical clarify of reflections at the mirror reflective element. The dampener element installed between the mirror mounting structure and the frame or back plate decreases the vibrational amplitude of the inside mirror. The dampener element may be formed from a soft rubber that absorbs the incoming vibrational force before it can travel into the mirror frame or back plate and affect the mirror's optical clarity. That is, the amplitude of the vibrational force is significantly less and has a lesser effect on optical clarity.

In some examples, the interior mirror assembly further offsets vibrational force by configuring the mirror assembly to have a natural frequency greater than common frequencies encountered at the mirror assembly. This ensures that effects to the optical clarify fall within expected standards. The dampener element further decreases the amplitude of incoming vibrational forces and thus increases the optical stability of the mirror assembly over a wide range of incoming excitation. Because the dampener element reduces or eliminates the amplitude of vibrational forces from reaching the mirror head, other vibration reducing elements and methods may be reduced, leading to costs and materials savings.

The interior mirror assembly may comprise a dual-mode interior rearview video mirror that can switch from a traditional reflection mode to a live-video display mode, such as is by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2021-0162926; US-2021-0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety. The operating mode of the mirror and video display screen may be selected by flipping the mirror head upward or downward (e.g., via a toggle located at the mirror head) or responsive to another user input. When the mirror is operating in the mirror mode, the video display screen is deactivated and rendered covert by the mirror reflective element, and the driver views rearward via reflection of light incident at the mirror reflective element. When the mirror is operating in the display mode, the video display screen is operated to display video images that are viewable through the mirror reflective element by the driver of the vehicle.

The back plate may comprise any suitable construction. Optionally, for example, a common or universal backplate, whereby the appropriate or selected socket element or pivot element (such as a socket element or such as a ball element or the like) is attached to the backplate to provide the desired pivot joint for the particular mirror head in which the backplate is incorporated. Optionally, when molding the backplate, a different insert may be provided to integrally mold a portion of or all of a ball member or the like (such as a portion of a base of a ball member, whereby the ball member may comprise a metallic ball member that is insert molded at the base and at the rear of the backplate during the injection molding process that forms the backplate, such as by utilizing aspects of the mirror assemblies described in U.S. Pat. Nos. 7,855,755; 7,249,860 and 6,329,925 and/or U.S. Pat. Pub. No. US-2006-0061008, which are hereby incorporated herein by reference in their entireties).

The reflective element and mirror casing are adjustable relative to a base portion or mounting assembly to adjust the driver's rearward field of view when the mirror assembly is normally mounted at or in the vehicle. The mounting assembly may comprise a single-ball or single-pivot mounting assembly, whereby the reflective element and casing are adjustable relative to the vehicle windshield (or other interior portion of the vehicle) about a single pivot joint, or the mounting assembly may comprise other types of mounting configurations, such as a double-ball or double-pivot mounting configuration or the like. The socket or pivot element is configured to receive a ball member of the base portion, such as for a single pivot or single ball mounting structure or a double pivot or double ball mounting structure or the like (such as a pivot mounting assembly of the types described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860 and/or 6,483,438, which are hereby incorporated herein by reference in their entireties).

The mounting base includes an attaching portion that is configured to be attached to an interior surface of a vehicle windshield (such as to a mounting button or attachment element adhered to the interior surface of the vehicle windshield or such as to a headliner or overhead console of the vehicle). The mounting base may comprise a metallic ball portion or may comprise a molded (such as injection molded) polymeric mounting base or may be otherwise formed, depending on the particular application of the mirror assembly.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

The video display screen may be controlled or operable in response to an input or signal, such as a signal received from one or more cameras or image sensors of the vehicle, such as a video camera or sensor, such as a CMOS imaging array sensor, a CCD sensor or the like, and image processors or image processing techniques, such as utilizing aspects of the cameras and image processors described U.S. Pat. Nos. 5,550,677; 5,670,935; 5,760,962; 6,498,620; 6,396,397; 6,222,447; 6,201,642; 6,097,023; 5,877,897; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606; 7,720,580; 11,165,975 and/or 11,613,209, and/or U.S. Pat. Pub. Nos. US-2006-0171704; US-2009-0244361 and/or US-2010-0214791, which are all hereby incorporated herein by reference in their entireties, or from one or more imaging systems of the vehicle, such as a reverse or backup aid system, such as a rearwardly directed vehicle vision system utilizing principles disclosed in U.S. Pat. Nos. 5,550,677; 5,760,962; 5,670,935; 6,201,642; 6,396,397; 6,498,620; 6,717,610 and/or 6,757,109, which are hereby incorporated herein by reference in their entireties, a trailer hitching aid or tow check system, such as the type disclosed in U.S. Pat. No. 7,005,974, which is hereby incorporated herein by reference in its entirety, a cabin viewing or monitoring device or system, such as a baby viewing or rear seat viewing camera or device or system or the like, such as disclosed in U.S. Pat. Nos. 5,877,897 and/or 6,690,268, which are hereby incorporated herein by reference in their entireties, a video communication device or system, such as disclosed in U.S. Pat. No. 6,690,268, which is hereby incorporated herein by reference in its entirety, and/or the like. The imaging sensor or camera may be activated and the display screen may be activated in response to the vehicle shifting into reverse, such that the display screen is viewable by the driver and is displaying an image of the rearward scene while the driver is reversing the vehicle. It is envisioned that an image processor or controller (such as an EYEQ™ image processing chip available from Mobileye Vision Technologies Ltd. of Jerusalem, Israel, and such as an image processor of the types described in U.S. Pat. No. 9,126,525, which is hereby incorporated herein by reference in its entirety) may process image data captured by the rearward facing camera to assess glare lighting conditions (such as to detect headlights of following vehicles that may cause glare at the interior and/or exterior rearview mirror assemblies of the equipped vehicle), and the controller may adjust or control the dimming of the electro-optic mirror assembly or assemblies of the equipped vehicle responsive to such image processing.

The mirror assembly may include a camera or sensor or light of a driver monitoring system and/or head and face direction and position tracking system and/or eye tracking system and/or gesture recognition system. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. provisional application Ser. No. 63/727,720, filed Dec. 4, 2024, and/or U.S. provisional application Ser. No. 63/641,574, filed May 2, 2024, and/or International Publication No. WO 2023/220222, which are hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

The mirror assembly may comprise or utilize aspects of other types of casings or the like, such as described in U.S. Pat. Nos. 7,338,177; 7,289,037; 7,249,860; 6,439,755; 4,826,289 and/or 6,501,387, which are all hereby incorporated herein by reference in their entireties. For example, the mirror assembly may utilize aspects of the flush or frameless or bezelless reflective elements described in U.S. Pat. Nos. 7,626,749; 7,360,932; 7,289,037; 7,255,451; 7,274,501 and/or 7,184,190, which are all hereby incorporated herein by reference in their entireties.

Optionally, the mirror assembly may comprise a modular mirror construction, and may include back housing portions or the like, such as cap portions of the types described in U.S. Pat. No. 7,289,037, which is hereby incorporated herein by reference in its entirety. A display screen may be provided as a modular display screen and may be mountable or installable in the appropriate or suitable mirror casing to provide a modular mirror assembly and display screen. For example, a rear casing or cap portion may include the display screen module including the associated components, such as the rails and motor and the like for a video slideout module (such as by utilizing aspects of the video mirrors described in U.S. Pat. Nos. 7,370,983 and 6,690,268, and/or U.S. Pat. Pub. Nos. US-2006-0050018 and/or US-2009-0015736, which are hereby incorporated herein by reference in their entireties), and may be attachable to a reflective element and/or mirror casing to assemble the modular mirror assembly. The display screen module thus may be provided as an optional component or accessory for a vehicle, and may be readily assembled to a common reflective element and/or mirror casing of the mirror assembly.

Changes and modifications in the specifically described embodiments may be carried out without departing from the principles of the present invention, which is intended to be limited only by the scope of the appended claims as interpreted according to the principles of patent law.

1. A vehicular interior rearview mirror assembly, the vehicular interior rearview mirror assembly comprising:
a mirror head adjustable about a mounting structure, wherein the mounting structure is configured to mount the vehicular interior rearview mirror assembly at an interior portion of an interior cabin of a vehicle;
wherein the mounting structure comprises a mounting arm having a ball member, and wherein a socket element is attached at structure of the mirror head and receives the ball member to adjustably mount the mirror head at the mounting arm;
wherein the mirror head includes a mirror reflective element;
wherein, with the vehicular interior rearview mirror assembly mounted at the interior portion of the interior cabin of the vehicle, the mirror head is adjustable by a driver of the vehicle to set a rearward view for the driver of the vehicle; and
a dampening element disposed between the socket element and the structure of the mirror head, wherein, with the vehicular interior rearview mirror assembly mounted at the interior portion of the interior cabin of the vehicle, the dampening element at least partially attenuates vibrations from transferring from the mounting structure to the mirror head.

2. The vehicular interior rearview mirror assembly of claim 1, wherein the socket element is attached at the structure of the mirror head via a threaded fastener, and wherein the dampening element circumscribes the threaded fastener.

3. The vehicular interior rearview mirror assembly of claim 2, wherein the dampening element comprises an O-ring.

4. The vehicular interior rearview mirror assembly of claim 1, wherein the structure of the mirror head comprises a mirror backplate, and wherein the mirror reflective element is attached at a first side of the mirror backplate and the socket element is attached at a second side of the mirror backplate opposite the first side.

5. The vehicular interior rearview mirror assembly of claim 1, wherein the structure of the mirror head comprises a mirror casing of the mirror head.

6. The vehicular interior rearview mirror assembly of claim 1, wherein the structure of the mirror head comprises a stanchion that is received within a recess of the socket element, and wherein the dampening element is disposed between the stanchion and the socket element within the recess.

7. The vehicular interior rearview mirror assembly of claim 6, wherein the dampening element is radially disposed between an outer circumferential surface of the stanchion and an inner circumferential surface of the socket element within the recess.

8. The vehicular interior rearview mirror assembly of claim 6, wherein the dampening element is axially disposed between an end surface of the stanchion and an end surface of the socket element within the recess.

9. The vehicular interior rearview mirror assembly of claim 6, wherein a threaded fastener extends through the socket element and is received at the stanchion to attach the socket element at the structure of the mirror head.

10. The vehicular interior rearview mirror assembly of claim 1, wherein the mirror head accommodates a video display screen, and wherein, with the vehicular interior rearview mirror assembly mounted at the interior portion of the interior cabin of the vehicle, the video display screen is electrically operable to display video images for viewing by the driver of the vehicle.

11. The vehicular interior rearview mirror assembly of claim 1, wherein the mirror head accommodates a driver monitoring camera that captures image data for a driver monitoring function.

12. A vehicular interior rearview mirror assembly, the vehicular interior rearview mirror assembly comprising:
a mirror head adjustable about a mounting structure, wherein the mounting structure is configured to mount the vehicular interior rearview mirror assembly at an interior portion of an interior cabin of a vehicle;
wherein the mounting structure comprises a mounting arm having a ball member, and wherein a socket element is attached at structure of the mirror head and receives the ball member to adjustably mount the mirror head at the mounting arm;
wherein the mirror head includes a mirror reflective element;
wherein, with the vehicular interior rearview mirror assembly mounted at the interior portion of the interior cabin of the vehicle, the mirror head is adjustable by a driver of the vehicle to set a rearward view for the driver of the vehicle;
wherein the structure of the mirror head comprises a mirror backplate, and wherein the mirror reflective element is attached at a first side of the mirror backplate and the socket element is attached at a second side of the mirror backplate opposite the first side, and wherein the socket element is attached at the mirror backplate via a threaded fastener; and
a dampening element disposed between the socket element and the mirror backplate, wherein the dampening element circumscribes the threaded fastener, and wherein, with the vehicular interior rearview mirror assembly mounted at the interior portion of the interior cabin of the vehicle, the dampening element at least partially attenuates vibrations from transferring from the mounting structure to the mirror head.

13. The vehicular interior rearview mirror assembly of claim 12, wherein the dampening element comprises an O-ring.

14. The vehicular interior rearview mirror assembly of claim 12, wherein the mirror head accommodates a video display screen, and wherein, with the vehicular interior rearview mirror assembly mounted at the interior portion of the interior cabin of the vehicle, the video display screen is electrically operable to display video images for viewing by the driver of the vehicle.

15. The vehicular interior rearview mirror assembly of claim 12, wherein the mirror head accommodates a driver monitoring camera that captures image data for a driver monitoring function.

16. A vehicular interior rearview mirror assembly, the vehicular interior rearview mirror assembly comprising:
a mirror head adjustable about a mounting structure, wherein the mounting structure is configured to mount the vehicular interior rearview mirror assembly at an interior portion of an interior cabin of a vehicle;
wherein the mounting structure comprises a mounting arm having a ball member, and wherein a socket element is attached at structure of the mirror head and receives the ball member to adjustably mount the mirror head at the mounting arm;
wherein the mirror head includes a mirror reflective element;
wherein, with the vehicular interior rearview mirror assembly mounted at the interior portion of the interior cabin of the vehicle, the mirror head is adjustable by a driver of the vehicle to set a rearward view for the driver of the vehicle;
wherein the mirror head accommodates a driver monitoring camera that captures image data for a driver monitoring function;
wherein the structure of the mirror head comprises a stanchion that is received within a recess of the socket element; and
a dampening element disposed between the stanchion and the socket element within the recess, wherein, with the vehicular interior rearview mirror assembly mounted at the interior portion of the interior cabin of the vehicle, the dampening element at least partially attenuates vibrations from transferring from the mounting structure to the mirror head.

17. The vehicular interior rearview mirror assembly of claim 16, wherein the dampening element comprises an O-ring.

18. The vehicular interior rearview mirror assembly of claim 16, wherein the dampening element is radially disposed between an outer circumferential surface of the stanchion and an inner circumferential surface of the socket element within the recess.

19. The vehicular interior rearview mirror assembly of claim 16, wherein the dampening element is axially disposed between an end surface of the stanchion and an end surface of the socket element within the recess.

20. The vehicular interior rearview mirror assembly of claim 16, wherein a threaded fastener extends through the socket element and is received at the stanchion to attach the socket element at the structure of the mirror head.
